(19) United States
(12) Patent Application Publication
(10) Pub. No.: US 2002/0046160 A1
(43) Pub. Date: Apr. 18, 2002

(54) On-line system and method for developing a data base of user demographic data and accruing compensation to users according to site member use of data

(76) Inventor: Thomas P. Conwell III, South Lyon, MI (US)

Correspondence Address: George L. Boller, Suite 316, 17199 North Laurel Park Drive, Livonia, MI, 48152, US

(21) Appl. No.: 09/837,101

(22) Filed: Apr. 18, 2001

Related U.S. Application Data
(60) Provisional application No. 60/197,730, filed on Apr. 18, 2000.

(51) Int. Cl. G06F 17/60

(52) U.S. Cl. 705/39

(57) ABSTRACT

A system and method for enabling users of a proprietor's site to receive compensation for use of their personal data by members of the site. A user accessing the site is afforded an opportunity to participate in receiving compensation for use of his or her personal data while maintaining his or her anonymity to members of the site. The site compiles a data base of personal data from users who elect to participate in receiving compensation for use of personal data that they furnish to the site. A request from a member for data from the data base based on criteria defined by the member is processed by processing equipment at the site and processed data is furnished to the member in response to the request from the member on a fee basis. The site accrues compensation to each individual user whose personal data was determined relevant to the request from the member and was processed in preparing the processed data furnished to the member. The site provides other options for user compensation while maintaining user anonymity to members.

### REFERENCE TO RELATED PATENT APPLICATIONS, INCORPORATION BY REFERENCE, PRIORITY CLAIM, AND NOTICE

This non-provisional patent application derives from commonly owned provisional patent application of the same inventor filed under the same title as Ser. No. 60/197,730 on Apr. 18, 2000. The content of that provisional patent application is incorporated herein by reference and its priority is expressly claimed. The eRef.net™ system referred to in this non-provisional patent application is described in the commonly owned pending patent application of the inventor, Ser. No. 09/452,489, filed Dec. 01, 1999, and its content is also incorporated herein by reference. Various trade and/or service marks used herein, including eIdentitytm and eRef.net™, are owned by the owner of the patent properties.

### FIELD OF THE INVENTION

This invention relates to novel systems, methods, and strategies for establishing and using an on-line site comprising a compiled data base containing data that is personal to individual users of the site wherein users voluntarily enter their own personal data into the data base, user data in the data base is processed in response to a member request for data based on criteria defined by the member, processed data is furnished to the member in response to the member request, and compensation is accrued to each individual user whose personal data was determined by the processing relevant to the request from the member and was in fact processed in preparing the processed data furnished to the member.

### BACKGROUND AND SUMMARY OF THE INVENTION

The owner's eRef.net™ system comprises an eIdentity™ component, and it is that component which is the subject of this non-provisional patent application.

In a general way, the eIdentity™ component relates to a system and a method for enabling users, i.e. consumers, to capitalize from their own demographic data which they themselves furnish on-line to a site data base referred to as a Confidential Demographic Data Repository.

Known market research techniques comprise companies compiling consumer data, and then using it to fuel their own internal marketing and demographic programs, and/or selling or renting the collected information to other firms who may then do the same. The consumer is left out of any potential revenue stream entirely.

The eIdentity™ component enables the consumer to benefit directly from his or her personal information. If a consumer elects to participate voluntarily in using the eIdentity™ component, he or she first furnishes various personal information requested by an on-line registration process. He or she then becomes eligible to collect revenue from an eRef™ member company when that company uses his or her personal information by accessing the eIdentity™ component through the eRef™ system. A member company can include user information in aggregate marketing data and/or in a direct solicitation to a user. The eRef™ system assures confidentiality of both user and member company until such time that certain mutual interest between user and company is indicated.

One generic aspect of the invention relates to a method for enabling users of a proprietor's site to receive compensation for use of their personal data by members of the site. The method comprises affording a user who is accessing the site an opportunity to participate in receiving compensation for use of his or her personal data while maintaining his or her anonymity to members of the site. A data base of personal data from users who elect to participate in receiving compensation for use of personal data that they furnish to the site is compiled at the site. The site processes a request from a member for data from the data base based on criteria defined by the member. Processed data responsive to the request from the member is furnished from the site to the member, and compensation is accrued at the site to each individual user whose personal data was determined by the processing step to be relevant to the request from the member and was processed in preparing the processed data furnished to the member.

Another generic aspect relates to a system that implements this method.

The foregoing, along with further aspects, features, and advantages of the invention, will be seen in the following disclosure of a presently preferred embodiment of the invention depicting the best mode contemplated at this time for carrying out the invention. This specification is accompanied by drawings that disclose a presently preferred embodiment of the eIdentity™ component of the eRef™ system.

### BRIEF DESCRIPTION OF THE DRAWINGS

FIG. 1 is a flow diagram for the eIdentity™ system.

FIG. 2 is a flow diagram for one portion of the eIdentity™ system, namely an eStats™ process.

FIG. 3 is a flow diagram for another portion of the eIdentity™ system, namely Member Usage.

FIG. 4 is a flow diagram for another portion of the eIdentity™ system, namely an eLeads™ process.

FIG. 5 is a flow diagram for another portion of the eIdentity™ system, namely an eList™ process.

### DESCRIPTION OF THE PREFERRED EMBODIMENT

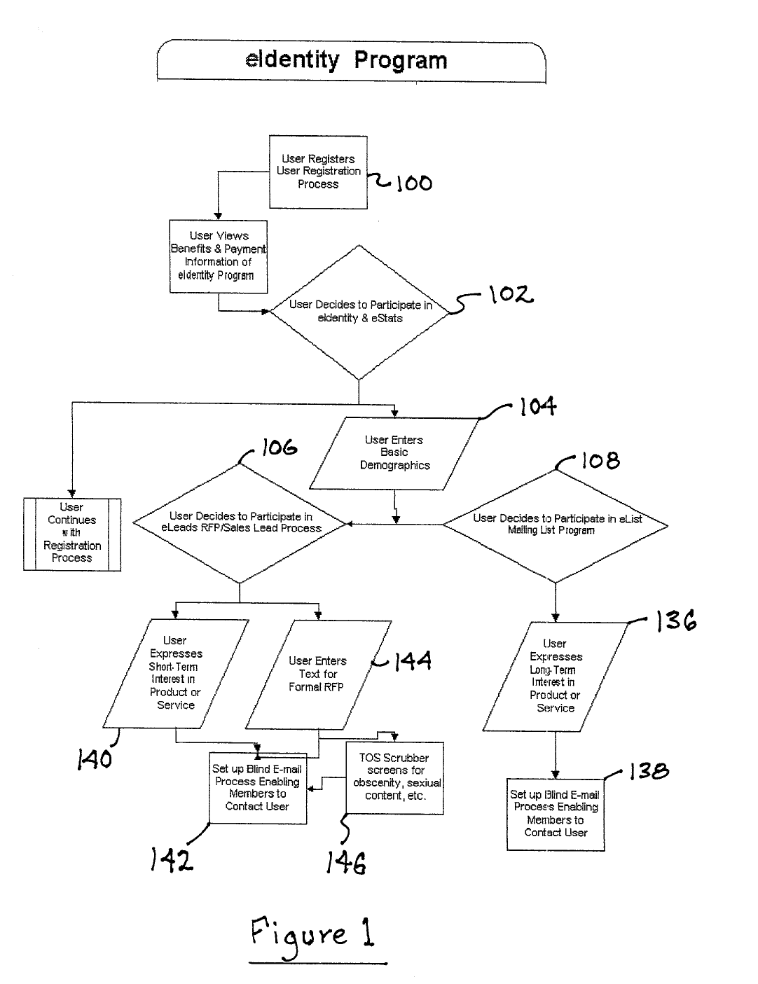

FIG. 1 shows that after a user (consumer) who has logged on to the eRef.net™ Internet site completes a free registration process (step 100) within eRef.net™, he or she is presented with the opportunity to participate in eStats™ and eIdentity™ processes (step 102). A decision to participate is followed by the site prompting the user to enter certain demographic data (step 104). After the data entry, the user is prompted to decide whether to participate in an eLeads™ RFP/Sales Lead process (step 106) and whether to participate in an eList™ Mailing List Program (step 108). The decisions made and the personal user data entered are stored in a data base at the site. Subsequently, the collected information is made available to a member company or firm, but only when certain conditions are satisfied, for example only when certain user data falls within criteria defined by a member company placing an inquiry request of the data base. This serves to define possible coincidence of interest between users and members companies because data that is not indicative of interest may not necessarily be furnished to a member company. The further steps in FIG. 1 will be described later, after description of other Figures.

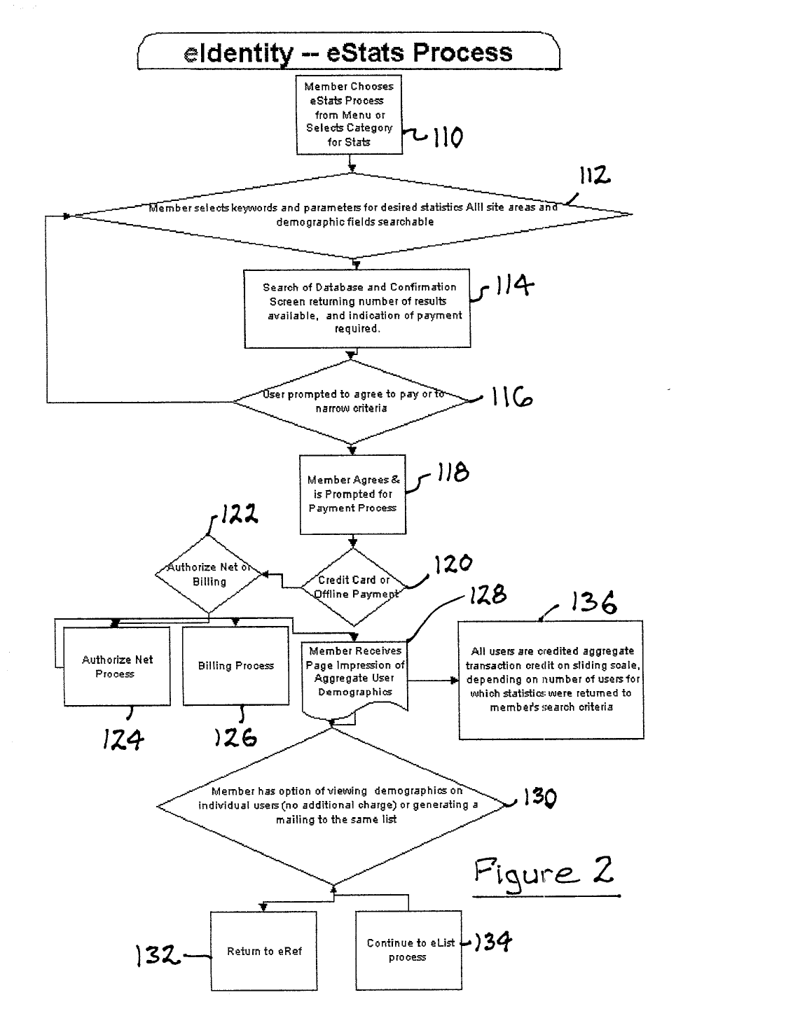

FIG. 2 shows that the eStats™ process is initiated by a member company accessing the data base via the eRef.net™ system (step 110). The member inputs a request that defines certain demographic parameters of interest (step 112), and the system processes the request against user data in the data base (step 114). At the conclusion of processing the request, a general indication of the result is furnished to the member, along with a fee for retrieving the result and making it available to the member. The member is then prompted either to agree to pay the quoted fee or to narrow the search criteria in the hope of securing a lesser fee (step 116).

Once the member obtains an indicated result, the fee for which is acceptable, it enters its agreement and is then prompted for a method of fee payment (step 118). The series of several steps 120, 122, 124, 126 relate to the fee payment. Once the payment has been confirmed, the actual result is furnished to the member (step 128). Subsequently, the member has options indicated by steps 130, 132, 134.

In accordance with certain principles of the invention, all or a portion of the fee paid by the member is allocated among the users whose data was used in compiling the result that the member paid for (step 136). In other words, all or portions of the fees from the sale of the consumer's demographic data are paid directly to the consumers whose personal information was used to compile the aggregate information, or a marketing list or a sales lead. At no time is any identifying information released, the company never obtains the consumers name, address or e-mail address. If the company wishes to forward an e-mail solicitation to the consumer, this is handled by eRef.net™ so that the consumer's privacy is protected at all times. If a user eventually receives a solicitation from a member company, he or she is free to respond to the solicitation or ignore it if it fails to be of interest. In other words a user always shares in revenue received by the eRef.net™ system simply for the use of the demographic data he or she has voluntarily furnished.

The fees collected are transferred directly to the consumer via credit card credit or by check. The consumer may collect 100% of all revenues earned from participation in the eIdentity program. Participation may occur in three different levels as follows.

1) Individual eIdentity™ data

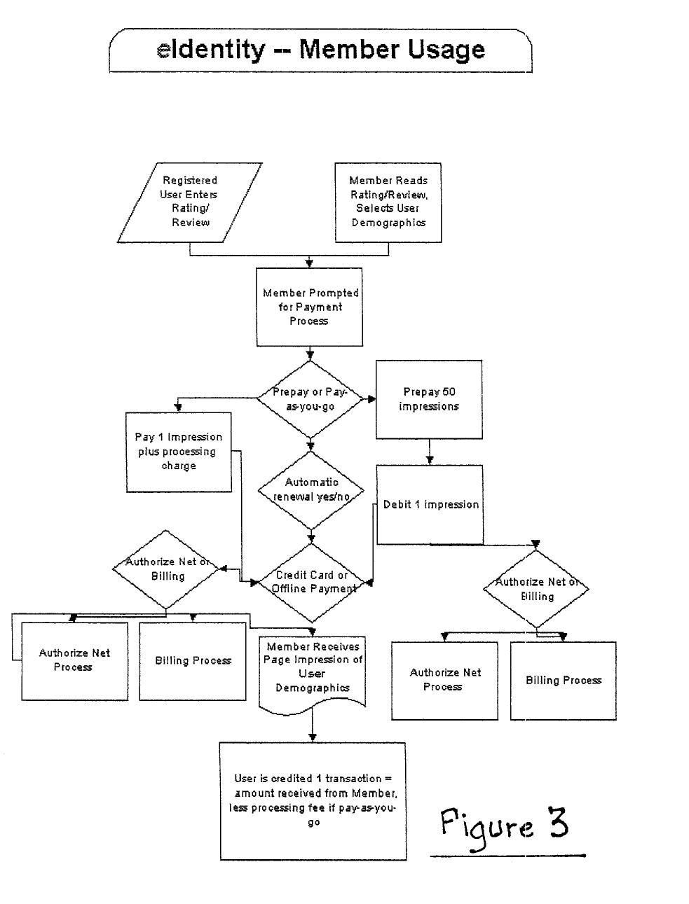

Members have the-option of purchasing demographic information available on any single consumer at a defined cost, for example $1 each (prepaid in counts of 50). The fees collected for demographic information are paid directly to the consumer whose data was accessed. FIG. 3 shows a detailed flow diagram.

2) eStats™ (Aggregate data)

Members order targeted aggregate marketing data; these lists are purely statistical, providing average market research data for any selected group of consumers. This information typically includes estimates of income, education, household size, amount of time spent online, business and personal interests (hobbies), buying and reading habits etc . . . This member has the ability to customize the search by using a multitude of different search criteria and limiters. All proceeds from eStats™ sales are credited directly to those consumers whose demographic data was used to compile the list.

3) eList™ (Solicitation lists)

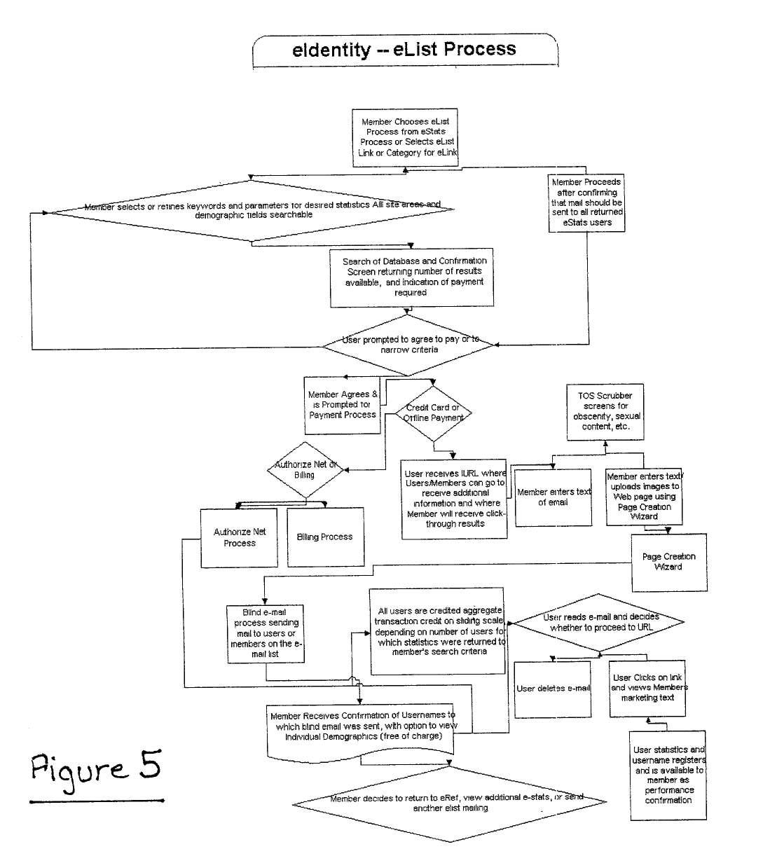

A targeted list of consumers is generated based on individual criteria established by the eRef.net member company. The member then produces an email-based solicitation that is forwarded by eRef.net via e-mail to all matching eIdentity™ participants. The appropriate fees are collected from the member and are credited to the users that received the solicitation. The cost of the solicitation list includes the delivery of the email promotion by eRef.net. FIG. 5 shows a detailed flow diagram.

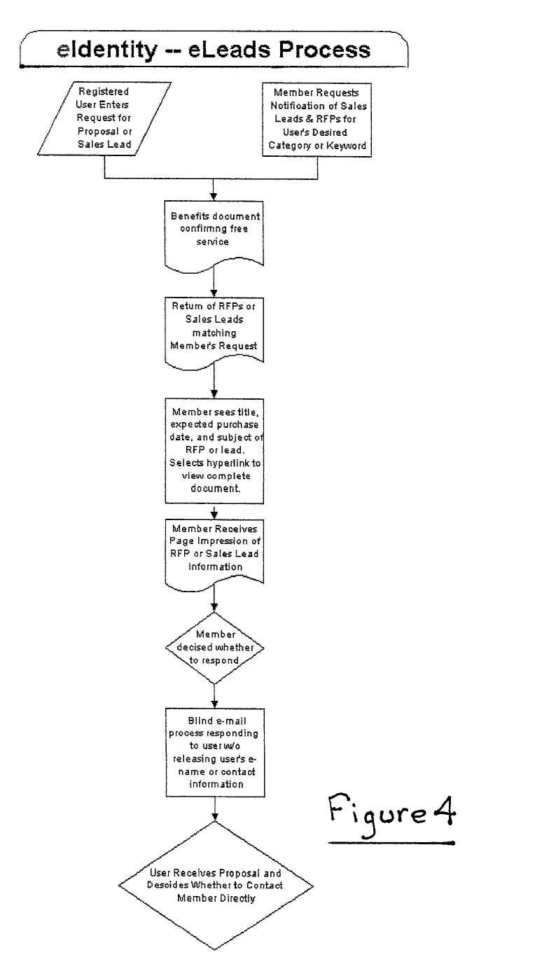

An additional capability is eRFP™ and eLeads™ (Request For Proposals and Sales Leads). Users have the ability to produce eRef.net™ Request For Proposals (eRFP's) where they identify the type of product or service they are looking for (and any other restrictions, i.e. geographic location). eRef.net using the categories and or key words identified in the eRFP, forward that inquiry via e-mail to the commercial members that have indicated interest in receiving inquiries in that area of commerce. Participation in the eRFP program is free to eRef.net users (consumers) and available to eRef.net members through annual subscription. FIG. 4 presents a detailed flow diagram of this process.

In view of the description given, and the flow diagrams of the various Figures, it is believed that the reader can appreciate the various steps in FIG. 1, the descriptions of which were postponed until now. Steps 136, 138 relate to the eList™ mailing program. Steps 140, 142, 144, 146 relate to eRFP™ and eLeads™ mailing programs.

The inventive system and method are embodied in an electronic on-line site that can be accessed by users and members using any suitable medium such as the Internet. User anonymity to a member is assured until such time as the user voluntarily discloses, or expressly consents to disclosure, of his or her identity. The site contains electronic equipment for establishing on-line communication with users and members, for processing data received from both users and members, and for furnishing data to both users and members. The flow diagrams that have been illustrated and described are considered compliant with prevailing law and rules regarding the manner for enabling disclosure of the inventive principles to those familiar with implementation of methods in on-line systems that can be accessed via the Internet.

While a presently preferred embodiment of the invention has been illustrated and described, it should be appreciated that principles of the invention apply to all embodiments falling within the scope of the following claims.

What is claimed is:

1. A method for enabling users of a proprietor's site to receive compensation for use of their personal data by members of the site, the method comprising:
affording a user who is accessing the site an opportunity to participate in receiving compensation for use of his or her personal data while maintaining his or her anonymity to members of the site;
compiling, at the site, a data base of personal data from users who elect to participate in receiving compensation for use of personal data that they furnish to the site;
processing, at the site, a request from a member for data from the data base based on criteria defined by the member;
furnishing processed data from the site to the member in response to the request from the member;
and accruing, at the site, compensation to each individual user whose personal data was determined by the processing step to be relevant to the request from the member and was processed in preparing the processed data furnished to the member.

2. A method as set forth in claim 1 wherein the processing step comprises determining at least an approximate fee that will be incurred by the member for furnishing processed data based on the criteria defined by request, and furnishing that approximate fee to the member before any processed data based on the criteria defined by the request is furnished to the member.

3. A method as set forth in claim 2 including the step of securing the member's agreement to the fee before the processed data based on the criteria defined by the request is furnished to the member.

4. A method as set forth in claim 3 wherein the processing step comprises furnishing processed data to the member based on the criteria defined by request once the member's agreement to the fee has been given.

5. A method as set forth in claim 4 wherein the step of accruing compensation to each individual user whose personal data was determined by the processing step to be relevant to the request from the member comprises accruing a portion of the fee to each such user.

6. A method as set forth in claim 4 including the step of generating a mailing containing information supplied by the member to at least some of the users whose personal data was determined by the processing step to be relevant to the request from the member and was processed in preparing the processed data furnished to the member.

7. A method as set forth in claim 6 wherein the step of generating a mailing comprises electronically mailing the information supplied by the member while maintaining the users who receive the information from the member anonymous to the member.

8. A method as set forth in claim 7 including the step of accruing compensation to each individual user to whom the information furnished by the member was electronically mailed.

9. A method as set forth in claim 1 wherein the processing step comprises furnishing data for particular users defined by the request based on fee payment by the member according to a fee schedule furnished to the member.

10. A method as set forth in claim 9 wherein the step of accruing compensation to each individual user whose personal data was determined by the processing step to be relevant to the request from the member and was processed in preparing the processed data furnished to the member comprises accruing a portion of the fee payment to each such individual user.

11. A method as set forth in claim 1 wherein the step of affording a user who is accessing the site an opportunity to participate in receiving compensation for use of his or her personal data comprises affording the user the opportunity to elect to receive mailings from members while the user remains anonymous to the members.

12. A method as set forth in claim 1 wherein the step of affording a user who is accessing the site an opportunity to participate in receiving compensation for use of his or her personal data comprises affording the user the opportunity to anonymously solicit a request for proposal from one or more members of the site.

13. A method as set forth in claim 12 including the step of processing through the site to a user who has solicited a request for proposal, a request for proposal from a member responding to the solicitation, while maintaining anonymity of the soliciting user to the responding member.

14. A system for enabling consumers to receive compensation for use of their personal data by members of an on-line site of a proprietor, the system comprising:
user access to the site comprising a menu that provides a user the opportunity to participate in receiving compensation for use of his or her personal data while maintaining his or her anonymity to members of the site;
a data base that is compiled at the site from personal data furnished by users who elect to participate in receiving compensation for use of personal data that they furnish to the site; and
processing equipment for processing a request from a member for data from the data base based on criteria defined by the member, for furnishing processed data from the site to the member in response to the request from the member, and for accruing compensation to each individual user whose personal data was determined to be relevant to the request from the member and was processed in preparing the processed data furnished to the member.

15. A system as set forth in claim 14 wherein the processing equipment determines at least an approximate fee that will be incurred by the member for furnishing processed data based on the criteria defined by request, furnishes that approximate fee to the member before any processed data based on the criteria defined by the request is furnished to the member, secures the member's agreement to the fee before the processed data based on the criteria defined by the request is furnished to the member, and furnishes processed data to the member based on the criteria defined by request once the member's agreement to the fee has been given.

16. A system as set forth in claim 15 wherein the processing equipment accrues compensation to each individual user whose personal data was determined by the processing step to be relevant to the request from the member by accruing a portion of the fee to each such user.

17. A system as set forth in claim 14 wherein the processing equipment generates a mailing containing information supplied by the member to at least some of the users whose personal data was determined to be relevant to the request from the member and was processed in preparing the processed data furnished to the member, and the mailing is electronically sent to such users while maintaining the identities of such users anonymous to the member.

18. A system as set forth in claim 14 wherein the processing equipment furnishes data for particular users defined by the request based on fee payment by the member according to a fee schedule furnished to the member, and accrues compensation to each individual user whose personal data was determined to be relevant to the request from the member and was processed in preparing the processed data furnished to the member by accruing a portion of the fee payment to each such individual user.

19. A system as set forth in claim 14 wherein the menu affords a user who is accessing the site an opportunity to participate in receiving compensation for use of his or her personal data by affording the user the opportunity to elect to receive mailings from members while the user remains anonymous to the member.

20. A system as set forth in claim 14 wherein the menu affords a user who is accessing the site an opportunity to participate in receiving compensation for use of his or her personal data by affording the user the opportunity to anonymously solicit a request for proposal from one or more members of the site, and the site transmits a request for proposal from a member responding to the solicitation, while maintaining anonymity of the soliciting user to the responding member.
